(19) United States
(12) Patent Application Publication
(10) Pub. No.: US 2007/0172031 A1
(43) Pub. Date: Jul. 26, 2007

(54) Concentric Dual Drum Raster Scanning Beam System and Method

(76) Inventors: William Randall Cason, Tewksbury, MA (US); Peter J. Rothschild, Boston, MA (US)

Correspondence Address: BROMBERG & SUNSTEIN LLP, 125 SUMMER STREET, BOSTON, MA, 02110-1618, US

(21) Appl. No.: 11/613,819

(22) Filed: Dec. 20, 2006

Related U.S. Application Data
(60) Provisional application No. 60/755,745, filed on Dec. 30, 2005.

(51) Int. Cl. G21K 5/10

(52) U.S. Cl. 378/146

(57) ABSTRACT

Devices and methods for collimation of a penetrating radiation source, such as an x-ray source, for the purpose of creating a scanning beam, as might be employed for purposes of imaging. A first scanning element, constrained to move about a first axis, has at least one aperture for scanning radiation from inside the first scanning element to outside the first scanning element. A second scanning element constrained to move with respect to a second axis, typically identical to the first, has at least one aperture for scanning radiation that has been transmitted through the first scanning element across a region of an inspected object.

The present application claims priority from U.S. Provisional Patent Application, Ser. No. 60/755,745, filed Dec. 30, 2005, which application is incorporated herein by reference.

### TECHNICAL FIELD

The present invention relates to devices and methods using penetrating radiation, and more particularly to collimation of a penetrating radiation source, such as an x-ray source, for the purpose of creating a scanning beam, as might be employed for purposes of imaging.

### BACKGROUND ART

Various applications require the scanning of a beam of radiation such as for the generation of an image based on scattering by pixels of a scene illuminated by the beam as successive instants of time. This is the basis, for example, of one modality for obtaining backscatter images using penetrating radiation such as x-rays. When the radiation to be scanned is penetrating radiation, such as x-rays or other high-energy electromagnetic radiation, scanning is often performed by rotation of a mechanical structure sufficiently dense and massive as to occlude the penetration other than at points where an aperture provides for emergence of the penetrating beam. Such mechanical chopper wheels tend to be extremely massive and ponderous and the scanning of the beam in more than a single dimension is typically cumbersome and costly.

### SUMMARY OF THE INVENTION

In accordance with preferred embodiments of the present invention, a beam scanning device is provided that has two scanning elements. A first scanning element is constrained to motion solely with respect to a first single axis and has at least one aperture for scanning radiation from inside the first scanning element to outside the first scanning element. A second scanning element is constrained to motion solely with respect to a second single axis and has at least one aperture for scanning radiation that has been transmitted through the first scanning element across a region of an inspected object.

In accordance with other embodiments of the invention, the first single axis and the second single axis may be substantially parallel to each other and may be substantially identical. The first scanning element may be a rotatable drum and may include one or more apertures disposed generally along a helical path for transmitting radiation from interior to the inner rotatable drum to a region external to the rotatable drum. The second scanning element may be disposed substantially exterior to the first scanning element, and at least one aperture of the second scanning element may be disposed in an orientation substantially parallel to the second singel axis.

In yet other embodiments of the invention, one or more apertures of the second scanning element may be aligned substantially linearly or may be disposed generally along a helical path.

The beam scanning device may also have a source of radiation disposed substantially within the first scanning element, which source may be an x-ray tube or a radioactive source, and may behave, effectively, as a point source. The source of radiation may be substantially concentric with the first scanning element.

A first actuator, which may be a motor, may be provided for driving the first scanning element in substantially continuous motion about the first single axis. A second actuator may be provided for driving the second scanning element in substantially continuous motion about the second single axis, either separately or in addition to the first actuator, or identical to the first actuator. The beam scanning device may also have a gear for constraining motion of the first scanning element with respect to motion of the second scanning element, and, more particularly, the gear may be a virtual gear implemented in a controller for governing relative rotation speeds of the first and second scanning elements.

In accordance with yet further embodiments of the invention, the beam scanning device may also include a first encoder for sensing at least one of an instantaneous position and a rate of rotation of the first scanning element, and a second encoder for sensing at least one of an instantaneous position and a rate of rotation of the second scanning element. An actuator may drive the first scanning element, and a controller may be provided for governing the actuator on the basis of at least one of the instantaneous position and rate of rotation of the first scanning element sensed by the first encoder.

In accordance with another aspect of the present invention, a method is provided for scanning a beam of radiation across a region in two dimensions for acquisition and display of a series of registered image frames. The method has steps of:
a. rotating a first scanning element about a first single axis the first scanning element having at least one aperture for scanning radiation from the inside the first scanning element to outside the first scanning element;
b. rotating a second scanning element about a second single axis, the second scanning element having at least one aperture for scanning radiation that has been transmitted through the first scanning element across a region of an inspected object; and
c. emitting radiation incident upon the first scanning element in such a manner that the radiation traverses the at least one apertures of the first scanning element and the at least one or more apertures of the second scanning element so as to scan the region in two dimensions.

In accordance with other embodiments of the invention, the method may also have a step of forming a beam at a momentary intersection of the at least one aperture of the first scanning element and the at least one aperture of the second scanning element, and a step of constraining motion of the second scanning element on the basis of motion of the first scanning element. The step of constraining may include constraining a rotational speed of the second scanning element to be one of a fixed sub-multiple or multiple of the rotational speed of the first scanning element, and, more generally, the first scanning element may be rotated at a rotational speed that is greater than that of the second scanning element.

### BRIEF DESCRIPTION OF THE DRAWINGS

The invention will be more readily understood by reference to the following description, taken with the accompanying drawings, in which:

FIG. 1 shows an exploded view of a beam scanning apparatus in accordance with preferred embodiments of the present invention, showing the inner and outer drums and a source of penetrating radiation;

FIG. 2 is a schematic depiction of methods for driving the beam scanning apparatus of FIG. 1; and

FIG. 3 depicts an exploded view of an embodiment of the invention having multiple apertures successively or concurrently illuminated.

### DETAILED DESCRIPTION OF EMBODIMENTS OF THE INVENTION

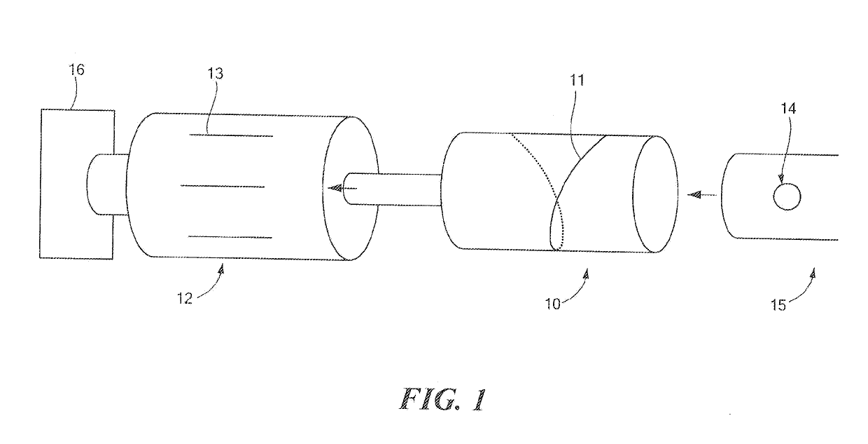

In accordance with preferred embodiments of the present invention, and as described with reference to FIG. 1, a cone of radiation, such as the x-ray cone produced by an x-ray source 14, may be collimated and scanned in two dimensions. Source 14 may be effective point source of radiation, including x-ray radiation. Cocentric cylindrical sleeves made of a material suitable for x-ray collimation (such as tungsten) are preferably used, as now described.

A first scanning element, such as inner sleeve 10, has helical slot 11 while a second scanning element, such as outer sleeve 12, has a horizontal slot 13. The end of a standard x-ray tube is shown as well. The respective slots provide for transmission of x-rays emitted from aperture 14 of x-ray source 15, typically an x-ray tube. One application of this invention is in the context of a portable machine capable of single-sided x-ray imaging of areas behind walls and the ceiling of a room. Inner 10 and outer 12 sleeves are rotated about their respective axes, typically a common axis, by means of one or more motors or other rotary actuators 16. As used herein and in any appended claims, the term “drum” may be used in place of the term “sleeve.”

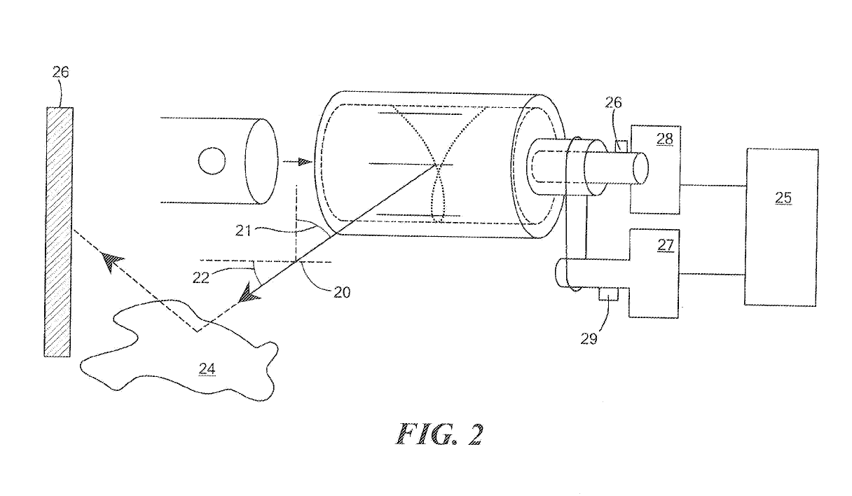

Operation of the combination of inner 10 and outer 12 sleeves is depicted in FIG. 2. When the inner sleeve 10 is fit inside the outer sleeve 12, intersections are formed between the helical slot 11 on the inner sleeve 10 and the horizontal slots 13 on the outer sleeve 12. When the x-ray tube end 15 is inserted into the inner sleeve 10, these intersections become apertures through which x-ray photons emitted from the x-ray tube may pass, producing a pencil-beam 20 of x-ray photons.

The instantaneous angular positions of the two sleeves 10 and 12 uniquely determine the horizontal 22 and vertical angles 21 of the beam 20. Scattered photons created by the beam striking an object 24 are detected by a detector 26, which may be a single-channel detector. The signal from this detector is correlated with the two angles of the beam to construct an image.

Most generally, it is advantageous, in various scenarios as described below, for example, for the rotation rates of the inner and outer sleeves to bear a fixed relationship, such as that of multiples or sub-multiples.

If the outer sleeve is not moving and one of its slots intersects the x-ray cone produced by the x-ray tube, rotating the inner sleeve about its cylindrical axis produces a moving pencil-beam in only the horizontal directions. If the outer sleeve is slowly rotated about its cylindrical axis at the same time, a pencil-beam is produced the scans in two dimensions in a manner similar to a cathode ray tube television set. The resultant scanning beam is suitable for x-ray Flying-Spot imaging, and may offer several advantages over current techniques, such as the following two advantages:
1. Single-dimension x-ray collimator designs require translation in the second dimension, of either the object being scanned or of the x-ray source and collimator. This design incorporates two-dimensional beam displacement into the collimator design itself, and does not require any more moving parts to produce two-dimensional Flying-Spot images. Removing the requirement of translation generally reduces the size and weight of the x-ray imaging system and allows portability and operation in tighter spaces. This disclosure describes a method for creating a flying spot beam of radiation which scans linearly in one dimension or can scan over a two dimensional area. It is compact, and allows for two-dimensional beam scanning with only one axis of rotation of any of the components.
2. Higher frame-rates are possible. In this design, many image frames can be scanned without reciprocating motion of any mass. A system using single-dimension collimation and translation of either the object being scanned, or of the x-ray source and collimator, must at a minimum, reverse the translation direction for each frame that is scans. This raster-scanning x-ray imaging system would be used much as a motion picture camera, giving a more “real-time” imaging system.
3. Image information from multiple image frames can be combined, allowing an initial, relatively poor quality image to be obtained in a short time period. If this image reveals any objects of interest, an arbitrary number of additional frames can be acquired, resulting in an image which continues to increase in clarity the longer the images are acquired. This allows larger objects to be scanned rapidly, without spending too much time on regions that prove to be of little interest.
   Sleeve Geometry and Theory of Operation

The embodiment of two concentrically disposed sleeves, as depicted in FIG. 2, is now discussed, with h referring to the number of helices on the helical sleeve. (It is to be understood that either ordering of inner and outer sleeve geometry is within the scope of the present invention.)

In the case where the helical sleeve is rotating faster that the slotted sleeve, for purposes of the following description, it is assumed that the speeds of the sleeves are constant. However, the scope of the present invention is not so constrained. At an instant that the angular relationship between the sleeves is such that the ends of one of the helices are aligned with one of the slots, one scan line is ending and another one is beginning. At this instant, the time that will elapse before the intersection of this same slot with the next helix, or the beginning of the next scan line, is given by the angle between the helixes on the helical sleeve, divided by the difference in angular velocity between the sleeves, and is called the “elapsed time per line,” t₁ , given in accordance with the following relation:

$${t}_{L} = \frac{2 π}{h ( {ω}_{helix} - {ω}_{slot} )} ,$$

where, for θ_{H}=the angle between helices on the sleeve =2π/h, and for Δ107 =the difference in angular velocity between the two sleeves, ωₕₑₗᵢₓ−ωₛₗₒₜ, the relation may also be expressed as t₁=θ_{H}/Δω.

In order to arrive at the angle between each scan line, the elapsed time per line is multiplied by the angular velocity of either of the two sleeves, in this case the slotted sleeve, yielding:

$${θ}_{L} = {ω}_{slot} {t}_{L} = \frac{2 π {ω}_{slot}}{h ( {ω}_{helix} - {ω}_{slot} )} = \frac{2 π}{h ( \frac{{ω}_{helix}}{{ω}_{slot}} - 1 )}$$

From this equation the gear ratio GR, which is equal to the ratio of the angular velocities of the sleeves may be obtained as:

$$GR = \frac{{ω}_{helix}}{{ω}_{slot}} = \frac{2 π}{{θ}_{L} h} + 1$$

This gear ratio of the sleeves, then, is the ratio required to acheive a given angle between scan lines for a specified number of evenly spaced helixes on the helical sleeve.

Moreover, if a frame angle is specified, the number of scan lines contained in the frame is given by the angle of the frame divided by the angle between the scan lines:

$$lines \text{/} frame = \frac{frame angle}{line angle} = \frac{{θ}_{F}}{{θ}_{L}}$$

If this relation is solved, in turn, for θ_{L}, then a gear ratio may be derived:

$$GR = \frac{2 π ( lines \text{/} frame )}{{θ}_{F} h} + 1$$

The above equation yields the gear ratio of the sleeves required to acheive a given number of scan lines in a given frame angle, with a given number of evenly spaced helixes on the helical sleeve.

In accordance with one embodiment of the invention, the sleeves may be “geared” by means of a feed-back controlled servo-motor system, although any other method is similarly within the scope of the present invention. Each of the two sleeves 10 and 12 is positioned by a servo-motor 27 and 28 that has an associated rotary-encoder feedback sensor 26 and 29. The rotary encoders typically employed in the art are electromechanical devices usually employing a mechanical coupling and an electrical output interface. This device produces a series of electronic pulses, as its coupling is rotated with respect to its stator. Each pulse represents a single angular displacement of the coupling with respect to the stator, yielding the ability to measure angular position. The servo controller uses this information to rapidly and precisely the motor to a commanded angle. Motors 27 and 28 are controlled by servo controller 25 capable of gearing the motors together by a ratio that is programmable in the software of the servo controller.

As used in this description, and in any appended claims, the term “gear” shall describe any coupling that constrains the motion of one of the sleeves about its axis to be a specified function of the motion of the other sleeve, whether such coupling is implemented in hardware (such as by mechanical gears, or otherwise) or in software, by virtue of drive commands applied to actuators 27 and 28 that respectively drive sleeves 10 and 12.

To use this collimator to aquire images, the position of the beam-defining aperture must be correlated with the signal from the scatter detector as the sleeves rotate. If the sleeves are tightly coupled together with a known gear ratio, the aperture's position along its rastered path can be measured by measuring the change in angular position of either of the sleeves alone. The current approach is to use the pulse signal from the same rotary-encoder feedback sensor that is used for the helical-sleeve's servo-motor. The helical sleeve is chosen for measurement, as it rotates faster and therefore has a higher displacement angle for a given displacement of the aperture than the slotted sleeve has. Given that the encoders on each sleeve are identical in measurement resolution, the helical sleeve's encoder will produce more measurements per unit-aperture-displacement than the slotted sleeve resulting in higher measurement precision of the aperture's position.

Each scan line represents a full helix on the helical sleeve 10 that has rotated past a slot 13 on the slotted sleeve 12. By picking a helical-sleeve encoder 26 with suitable resolution, the encoder allows the scan line to be constantly monitored while it is in progress, yielding the position of the aperture along a particular slot. This information is correlated with the detector signal to form spatially-correlated pixels within each scan line, suitable for imaging. Given that the two sleeves are geared together, the same encoder may also be used, in some embodiments, to yield the position of the beam along either the horizontal or vertical axes. Correlating the encoder signal with the detector signal allows two-dimensional image construction, for example, construction of a backscatter image, where a backscatter detector 26 is employed. Note that the mathematical analysis presented here assumes that the source of x-rays is on the axis of the two cylinders, although this does not necessarily need to be the case to be within the scope of the invention.

Embodiment Minimizing Time Between Frames

In one embodiment of the invention, a helical collimator sleeve assembly produces an x-ray beam particularly advantageous for acquisition of a high-speed series of image frames. In this embodiment, the number of slots on the slotted sleeve would be chosen depending on the desired frame angle to minimize the time between frames. To optimize the coverage of x-rays per frame, the frame angle should be equal to or less than the angle of the x-ray cone. For example, if the x-ray cone has an opening of 93 degrees, the number of slots chosen would be four, as that would produce the maximum frame angle, while reducing the time between frames. This establishes the frame angle as:

$$frame angle = {θ}_{F} = \frac{2 π}{s}$$

The condition imposed on the gear ratio becomes:

$$Gear Ratio \frac{helicalsleeve}{slottedsleeve} = \frac{{ω}_{helix}}{{ω}_{slot}} = \frac{s ( lines \text{/} frame )}{h} + 1$$

Increasing the value of h allows more scan lines per rotation of the helical sleeve, allowing, in turn, a lower angular velocity. However, it makes the aperture shape and x-ray beam cross-section less “square”. The value of s is chosen depending on the x-ray cone angle.

In this embodiment, it is required that the rotation of the two sleeves be constant and that a frame of scanned x-rays is produced for every consecutive slot. It is also required that the first line of every consecutive frame, be at the same angle so that every scanned frame is at the same angle. This constrains the gear ratio as follows.

As the outer sleeve rotates one slot angle, or 1 frame, the inner sleeve rotates by an amount given by the angle of slot rotation times the gear ratio, or

$${θ}_{helicalsleeve} = GR * \frac{2 π}{s} .$$

For the first time line of each frame to begin at the same angle, the angular displacement of the helix, θ_{helicalsleeve}, must be an integer multiple of the angle between helices, thereby constraining the gear ratio to be

$${GR}_{constrained} \frac{2 π}{s} = n \frac{2 π}{h} .$$

with n a non-zero integer.

Simplifying, and solving for the gear ratio, leads to:

$${GR}_{constrained} = n \frac{s}{h} .$$

Or, with substitution from an earlier relation described above,

$${θ}_{{L}_{constrained}} = \frac{2 π}{{GR}_{constrained} * h} + 1$$

$$or$$

$${θ}_{{L}_{constrained}} = \frac{2 π}{( n * s ) - h}$$

This leads to the following constraint on the number of lines per frame:

$$lines \text{/} {frame}_{constrained} = \frac{{θ}_{F}}{{θ}_{{L}_{constrained}}}$$

In other words, the number of lines per frame must be constrained to the above if the collimator is required to produce a series of consectutive frames at the same angle with constant angular velocity of each sleeve. If the angular position of the helical slot were measure using a device with a specific minimum angle per measurement (such as an optical encoder) and the number of encoder counts within the constrained line angle is specified as CPL_{constrained}, the constrained number of encoder counts per revolution is given by:

$${CPR}_{constrained} = \frac{2 π}{{θ}_{{L}_{constrained}}} {CPL}_{constrained} .$$

From the beginning of one line to the beginning of the next, the helical sleeve will have rotated an amount equal to the angle between helices plus the constrained line angle. In encoder counts, this is equal to

$$total encoder counts between lines = \frac{CPR}{h} + CPL .$$

If the encoder's count are counted, the above equation allows the formation of a line-synchronization pulse at the beginning of every scan line for correlation with the detector's signal. In order for the aspect ratio of the images produced to be as close to 1:1 as possible, the number of pixels per line should be equal to the constrained number of lines per frame, i.e., pixels/line=lines/frame_{constrained}.

Moreover, if the location of each pixel is defined by counting a specified number of encoder counts, then the total number of encoder counts per pixel is given by:

$$total encoder counts between pixels = \frac{total encoder counts between lines}{pixels \text{/} line} .$$

The above equation allows the formation of a pixel-synchronization pulse at the beginning of each pixel for correlation with the detector signal. Note that the result of the above equation must be rounded down in cases where the encoder precision is limited to integral counts.

Embodiments Allowing for Delay Between Frames

Certain applications of a collimator assembly require that a single image frame be produced as a time, but allow for a certain delay between frames. In this case, a single helix and a single slot may be provided for any frame angle, allowing easier manufacture and better optical repeatability from line to line. This allows the angle between lines to be specified without constraint, as it is not required that angular velocities of the two sleeves remain constant between frames. This allows more flexibility in the selection of rotary encoder resolution.

In such embodiments, the ends of the helix are aligned with the slot at the beginning of a frame. The sleeves begin rotating, and a single image frame is acquired. Then the sleeves are rotated back to their initial positions for a new frame.

Thus, the gear ratio is given, as calculated above, but with h equal to 1, by:

$$GR = \frac{2 π ( lines \text{/} frame )}{{θ}_{F}} + 1$$

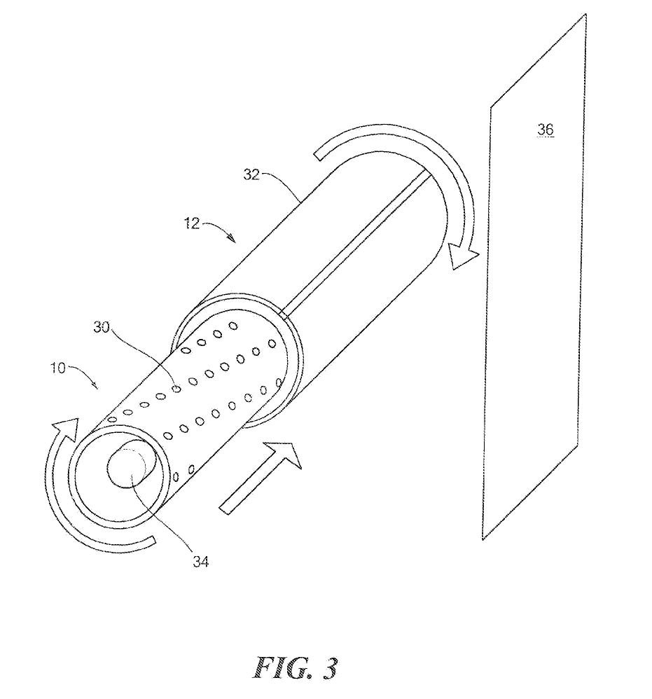

Instead of a slit, it is to be understood that multiple apertures 30 may be provided, as shown in the exploded view of FIG. 3, in the radiation-opaque material (such as lead, steel, or tungsten) that is the same as that used for the drum 32, and, in the case of the helical structure, multiple apertures may be located along a helical line (or lines).

An x-ray tube (or some other source of x-ray or gamma radiation) 34 is located inside the inner drum 10, which consists of a material which is opaque to the radiation. The radiation source can be at the center of the drum or it can be offset from the center. An outer drum 12 of material (also opaque to the radiation) surrounds the inner drum and contains a slit which is transparent (or almost transparent) to the radiation. A series of apertures are made in the inner drum such that, as the drum rotates, only one aperture (called the “illuminated aperture”) is aligned with the slit in the outer drum at any given time. As the inner drum rotates, the x-rays emitted from the source are only able to escape through the illuminated aperture, with the result that the escaping beam of x-rays will be raster-scanned in the horizontal direction. If the outer drum containing the slit is also slowly rotated, the beam will be raster scanned in both the horizontal and vertical directions, allowing a two-dimensional area to be scanned.

Note that, in accordance with further embodiments of the invention, one or more apertures may be illuminated at any given time, allowing for the possibility of having multiple raster scanning beams. It is also to be understood that any orientation of the drums with respect to the object being scanned in inspection plane 36 can be employed, so that, for example, the drums could be oriented in a vertical direction.

For the purpose of illustrating the invention, various exemplary embodiments have been described with reference to the appended drawings, it being understood, however, that this invention is not limited to the precise arrangements shown. Indeed, numerous variations and modifications will be apparent to those skilled in the art. One such variation is to use helical slots in the outer drum, in combination with helical slots in the inner drum. All such variations and modifications are intended to be within the scope of the present invention.

What is claimed is:

1. A beam scanning device comprising:
a. a first scanning element constrained to motion solely with respect to a first single axis and having at least one aperture for scanning radiation from inside the first scanning element to outside the first scanning element; and
b. a second scanning element constrained to motion solely with respect to a second single axis and having at least one aperture for scanning radiation that has been transmitted through the first scanning element across a region of an inspected object.

2. A beam scanning device in accordance with claim 1, wherein the first single axis and the second single axis are substantially parallel to each other.

3. A beam scanning device in accordance with claim 1, wherein the first single axis and the second single axis are substantially identical.

4. A beam scanning device in accordance with claim 1, wherein the first scanning element is a rotatable drum.

5. A beam scanning device in accordance with claim 1, wherein the first scanning element includes one or more apertures disposed generally along a helical path for transmitting radiation from interior to the inner rotatable drum to a region external to the rotatable drum.

6. A beam scanning device in accordance with claim 1, wherein the second scanning element is disposed substantially exterior to the first scanning element.

7. The beam scanning device of claim 1, wherein the at least one aperture of the second scanning element are disposed in an orientation substantially parallel to the second single axis.

8. The beam scanning device of claim 7, wherein the one or more apertures of the second scanning element are substantially linear.

9. The beam scanning device of claim 7, wherein the one or more apertures of the second scanning element are disposed generally along a helical path.

10. The beam scanning device of claim 1, further comprising a source of radiation disposed substantially within the first scanning element.

11. The beam scanning device of claim 10, wherein the source of radiation is an x-ray tube.

12. The beam scanning device of claim 10, wherein the source of radiation is a radioactive source.

13. The beam scanning device of claim 10, wherein the source of radiation is effectively a point source.

14. The beam scanning device of claim 10, wherein the source of radiation is substantially concentric with the first scanning element.

15. The beam scanning device of claim 1, further comprising a first actuator for driving the first scanning element in substantially continuous motion about the first single axis.

16. The beam scanning device of claim 1, wherein the first actuator is a motor.

17. The beam scanning device of claim 1, further comprising a second actuator for driving the second scanning element in substantially continuous motion about the second single axis.

18. The beam scanning device of claim 15, further comprising a second actuator for driving the second scanning element in substantially continuous motion about the second single axis.

19. The beam scanning device of claim 18, wherein the second actuator is identical to the first actuator.

20. The beam scanning device of claim 1, further comprising a gear for constraining motion of the first scanning element with respect to motion of the second scanning element.

21. The beam scanning device of claim 20, wherein the gear is a virtual gear implemented in a controller for governing relative rotation speeds of the first and second scanning elements.

22. The beam scanning device of claim 1, further including a first encoder for sensing at least one of an instantaneous position and a rate of rotation of the first scanning element.

23. The beam scanning device of claim 22, further including a second encoder for sensing at least one of an instantaneous position and a rate of rotation of the second scanning element.

24. The beam scanning device of claim 22, further including an actuator for driving the first scanning element and a controller for governing the actuator on the basis of at least one of the instantaneous position and rate of rotation of the first scanning element sensed by the first encoder.

25. A method for scanning a beam of radiation across a region in two dimensions for acquisition and display of a series of registered image frames, the method comprising:
a. rotating a first scanning element about a first single axis, the first scanning element having at least one aperture for scanning radiation from inside the first scanning element to outside the first scanning element;
b. rotating a second scanning element about a second single axis, the second scanning element having at least one aperture for scanning radiation that has been transmitted through the first scanning element across a region of an inspected object; and
c. emitting radiation incident upon the first scanning element in such a manner that the radiation traverses the at least one apertures of the first scanning element and the at least one or more apertures of the second scanning element so as to scan the region in two dimensions.

26. A method in accordance with claim 25, further comprising a step of forming a beam at a momentary intersection of the at least one aperture of the first scanning element and the at least one aperture of the second scanning element.

27. A method in accordance with claim 25, further comprising a step of constraining motion of the second scanning element on the basis of motion of the first scanning element.

28. A method in accordance with claim 27, wherein the step of constraining includes constraining a rotational speed of the second scanning element to be one of a fixed sub-multiple or multiple of the rotational speed of the first scanning element.

29. A method in accordance with claim 28, wherein the step of rotating the first scanning element includes rotating the first scanning element at a rotational speed greater than that of the second scanning element.
